(19) United States
(12) Patent Application Publication
(10) Pub. No.: US 2008/0086703 A1
(43) Pub. Date: Apr. 10, 2008

(54) Preview expansion of list items

(75) Inventors: David W. Flynt, Lake Forest Park, WA (US); Micah Shotel, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/544,263

(22) Filed: Oct. 6, 2006

(51) Int. Cl. G06F 3/048

(52) U.S. Cl. 715/853; 715/851; 715/767

(57) ABSTRACT

Computing devices such as mobile devices are typically limited in display size. Information on the devices can be typically displayed in list form, which often allows a user to locate desired information more quickly. Lists of information can be condensed by list items so that an item can be identified using relatively small display space. The condensed list items can be expanded and previewed by implicitly indicating a desired list item. Preview expansion of list items often allows condensed, richer lists of information to be quickly browsed, while maximizing the number of items that are viewable at the same time without having to scroll.

### BACKGROUND

Mobile computing devices such as mobile devices are typically limited in display size. Accordingly, the amount of information that can be displayed in one screen without scrolling is relatively limited. The limited size of the display limits the ease-of-use of the device because less space is available for providing information to a user. A user often has to scroll through a window to locate desired information.

Often, the information can be provided as a list, which often allows a user to locate a desired item more quickly. Formatting content items in list views for such a display often results in various trade-offs between showing more list items (with less content for each item) and showing more content per item (with less items on screen visible without scrolling).

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The present disclosure is directed to expansion of list items for previewing. Lists of information can be condensed by list items so that an item can be identified using relatively small display space. The condensed list items can be expanded and previewed by implicitly indicating a desired list item. Preview expansion of list items often allows condensed, richer lists of information to be quickly browsed, while maximizing the number of items that are viewable at the same time without having to scroll.

Also, preview expansion allows content items to be examined quickly with out having to “dive deeper” into the application. This typically allows a user to quickly prioritize content and/or information (content) and decide whether to investigate further.

List items can be expanded, for example, by hovering and/or moving a cursor over a list item, which indicates that a user is “focusing” on the list item. Hovering can be accomplished by moving a cursor over an item (an implicit command), and not giving another explicit command (such as mouse clicking) to select the item over which the cursor is hovered. When the focus is provided over an expand-on-focus list item, previews of content are “surfaced” to the user by presenting a detailed view of content and/or information associated with the list item. Content can also be condensed to “core information” to be ready for expansion when the focus is upon a condensed list item.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for preview expansion of list items.

FIG. 2A is an illustration of a display of condensed list items of photographs on a device.

FIG. 2B is an illustration of a display of a focused list item of a collection of photographs on a device.

FIG. 3A is an illustration of a display of condensed list items of contact methods on a device.

FIG. 3B is an illustration of a display of a focused list item of a collection of contact methods on a device.

FIG. 4A is an illustration of a display of condensed list items of email messages on a device.

FIG. 4B is an illustration of a display of a focused list item of a collection of email messages on a device.

FIG. 4C is an illustration of a display of another focused list item of a collection of email messages on a device.

FIG. 5A is an illustration of another display of condensed list items of email messages on a device.

FIG. 5B is an illustration of a display of a focused list item of a collection of email messages on a device.

FIG. 6A is an illustration of a display of condensed list items of email messages on a device that are sorted by message type.

FIG. 6B is an illustration of a display of a focused list item of a collection of email messages on a device.

FIG. 7A is an illustration of a display of condensed list items of various types of preview information.

FIG. 7B is an illustration of a display of a focused list item of a collection of email messages on a device.

FIG. 8A is an illustration of a desktop display of condensed list items of various types of preview information.

FIG. 8B is an illustration of a desktop display of a focused list item of a collection of email messages on a device.

FIG. 9 is a top-level illustration of a flow diagram for preview expansion of list items.

### DETAILED DESCRIPTION

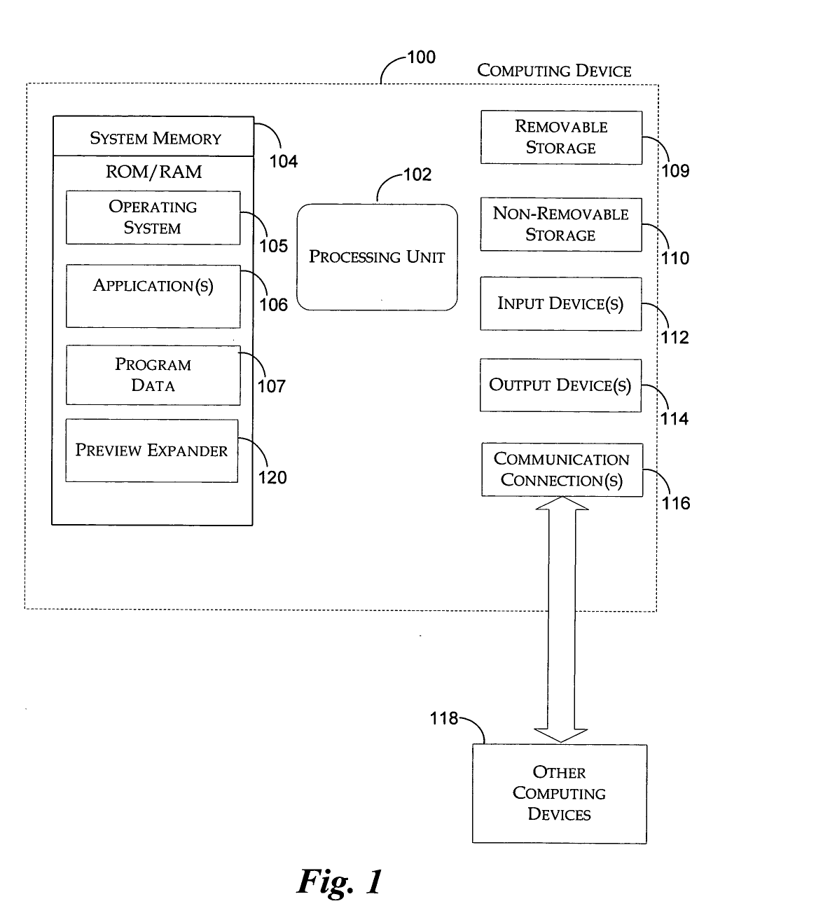

As briefly described above, embodiments are directed to dynamic computation of identity-based attributes. With reference to FIG. 1, one example system for expansion of list items for previewing includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 such that data store monitor 120, attribute computer 122, and cache 124 can be implemented (which are discussed below).

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

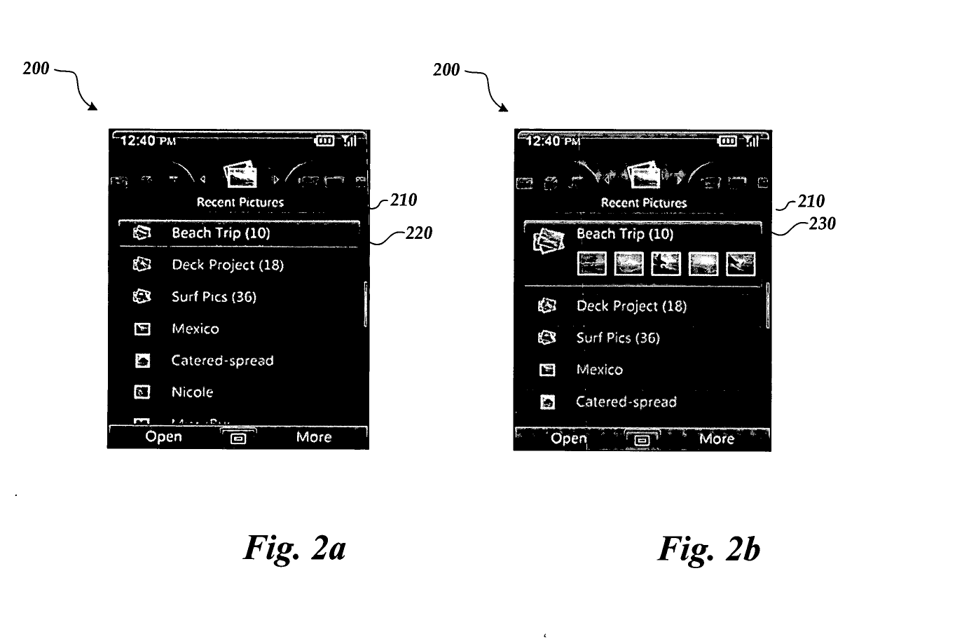

In accordance with the discussion above, computing device 100, system memory 104, processor 102, and related peripherals can be used to implement preview expander 120. Preview expander 120 in an embodiment can be used to implement expansion of list items for previewing (described below with reference to FIGS. 2-8).

Lists of content are displayed using a wide variety of platform types. The content, which is itemized in a list, is often displayed on mobile devices, which typically have relatively limited display space. The content can be embodied in many forms, including contact information, calendar items, mail, music, photos, documents, tasks, and the like.

Using the preview expander, a list can be condensed down to its core information in order to maximize the number of individual items presented in the list and then expanded when the displayed core information of the list item comes into the focus of a user. For example, a user can pause on an item (such as by hovering the cursor) to bring a list item into focus and view additional content related to that item upon expansion.

The content for display could be obtained from the device being used and/or from the external network/content providers. Expand-on-focus list items are not limited to a preview of content and can contain interactivity with a touch screen or with “D pad” and/or joystick controls, for example. The interactivity thus allows a user to select a desired portion of content from the preview.

As an example, a mail list view in a conventional device with a limited display area using a typical two line item high content item might show only four items with sender and subject name. An expand-on-focus system on the same device could provide a user with six or more single line high items by displaying the sender name (only) with the list item in focus displaying both the sender and subject names. Thus the user could glance at the list to more quickly determine whether mail from important people is present, and then move through the list expanding the items of interest to determine if they should be read immediately. Items in the list can also be expanded hierarchically.

FIG. 2A is an illustration of a display of condensed list items of photographs on a device. A collection of photographs can be condensed to the title of the group and the number of items in the group. A Display 200 displays a list 210 of condensed items 220, which displays the title of each group and the number of items in each group for each list item.

FIG. 2B is an illustration of a display of a focused list item of a collection of photographs on a device. When a user focuses upon a condensed item 220, the list item is expanded to produce an expanded list item 230. Display 200 displays expanded list item 230, which displays thumbnail pictures for photographs within the collection.

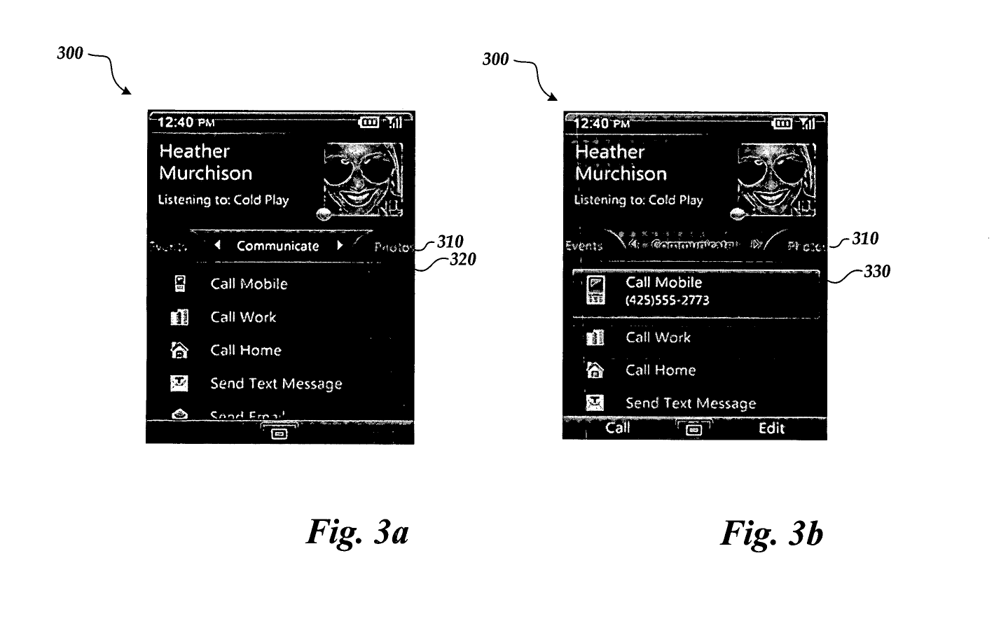

FIG. 3A is an illustration of a display of condensed list items of contact methods on a device. A contact methods list can be condensed to the method type and/or location. A Display 300 displays a list 310 of condensed items 320, which displays the method type and/or location for each list item.

FIG. 3B is an illustration of a display of a focused list item of a collection of contact methods on a device. When a user focuses upon a condensed item 320, the list item is expanded to produce an expanded list item 330. Display 300 displays expanded list item 330, which displays contact information such as a phone number, email address, and the like.

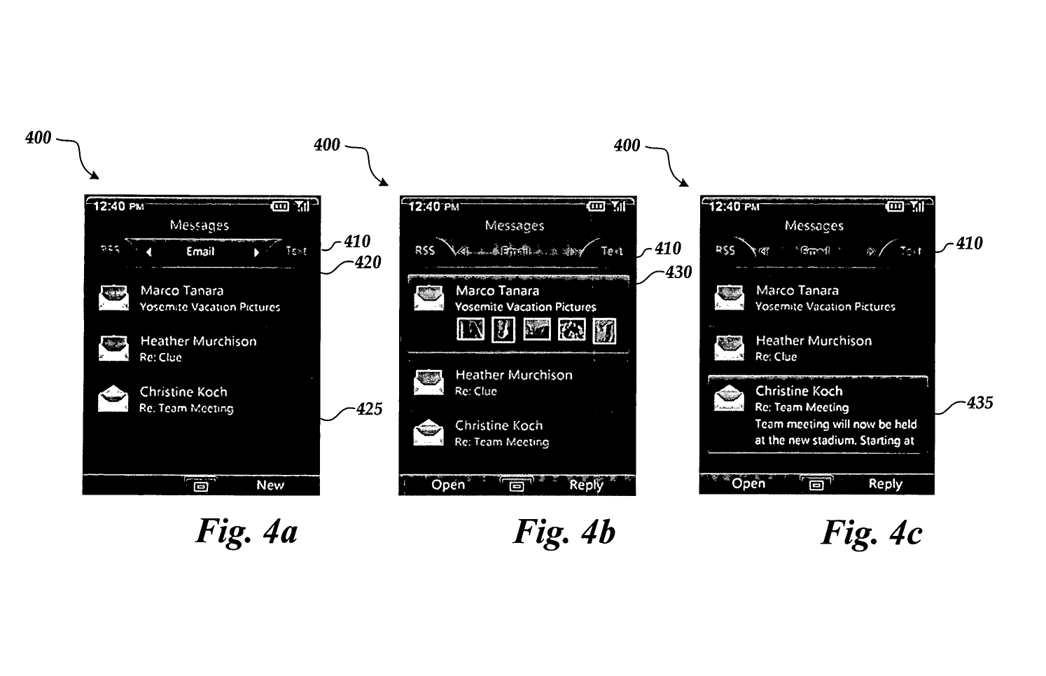

FIG. 4A is an illustration of a display of condensed list items of email messages on a device. An email list of messages can be condensed to the sender or the sender and subject, for example. A Display 400 displays a list 410 of condensed items 420, which displays the sender name and the subject of the message.

FIG. 4B is an illustration of a display of a focused list item of a collection of email messages on a device. When a user focuses upon a condensed item 420, the list item is expanded to produce an expanded list item 430. Display 400 displays expanded list item 430, which displays thumbnail pictures for photographs within, attached to, or otherwise associated with the email message.

FIG. 4C is an illustration of a display of another focused list item of a collection of email messages on a device. When a user focuses upon a condensed item 425, the list item is expanded to produce an expanded list item 435. Display 400 displays expanded list item 435, which displays subject information and partial contents of the email message.

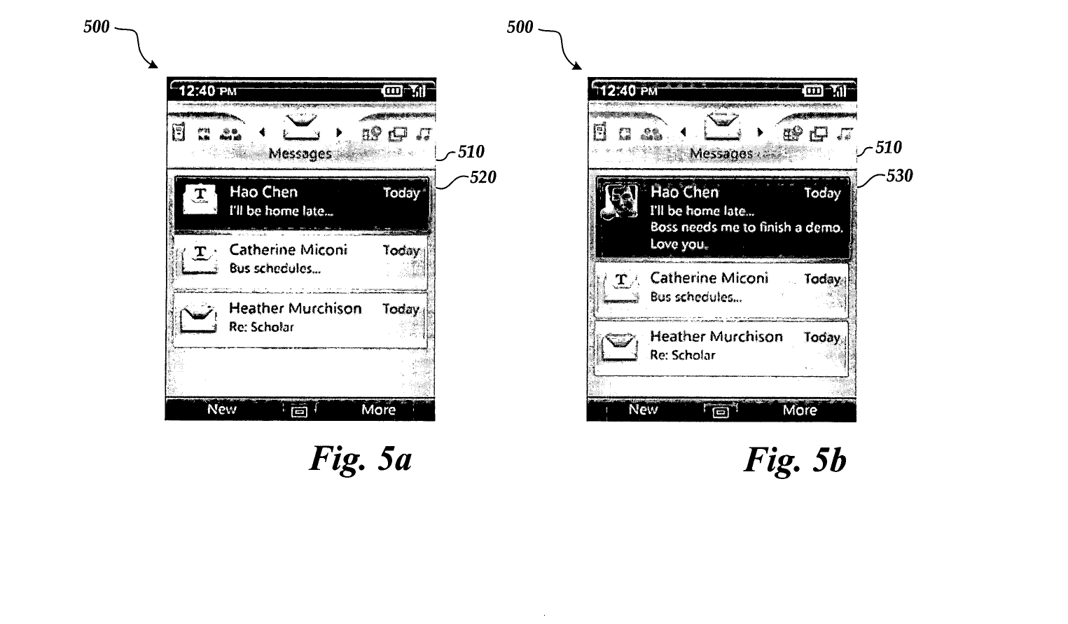

FIG. 5A is an illustration of another display of condensed list items of email messages on a device. An email list of messages can be condensed to the sender or the sender and subject, for example. A Display 500 displays a list 510 of condensed items 520, which displays a message type icon, the sender name and the subject of the message.

FIG. 5B is an illustration of a display of a focused list item of a collection of email messages on a device. When a user focuses upon a condensed item 520, the list item is expanded to produce an expanded list item 530. Display 500 displays expanded list item 530, which displays a thumbnail picture of the sender of the email and additional text from the email message. The thumbnail picture can be stored within, attached to, or otherwise associated with the email message.

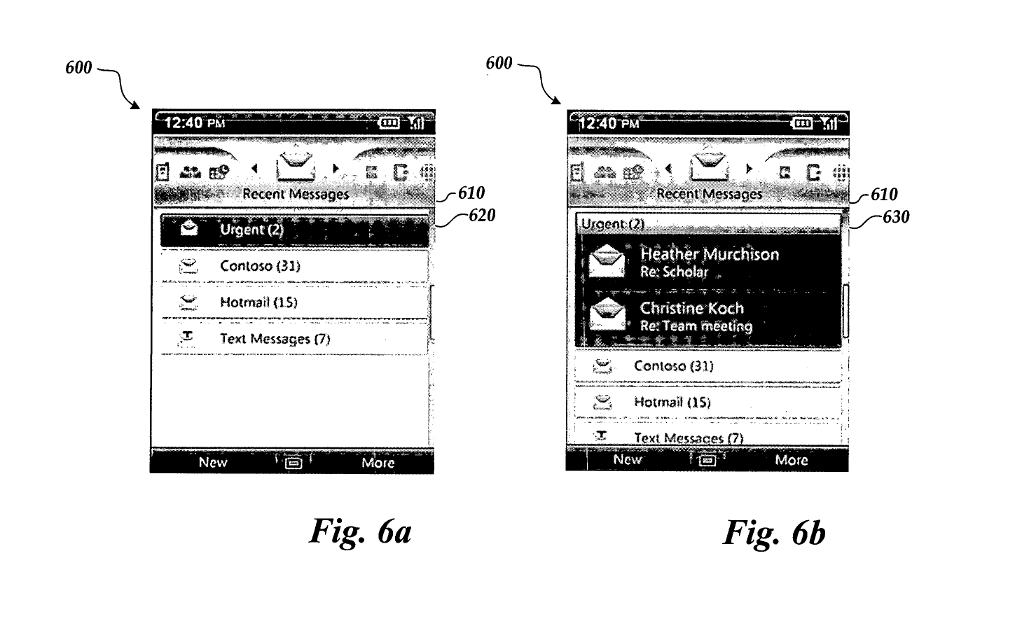

FIG. 6A is an illustration of a display of condensed list items of email messages on a device that are sorted by message type. An email list of messages can be condensed to the type of email, for example. The emails can be sorted by the type of the email such as the type of email contents, the source (such as by different mail servers), predetermined categories (such as defined by filters), priority of emails (such as level of urgency), and the like. Display 600 displays a list 610 of condensed items 620, which displays the type and subject of the message.

FIG. 6B is an illustration of a display of a focused list item of a collection of email messages on a device. When a user focuses upon a condensed item 620, the list item is expanded to produce an expanded list item 630. Display 600 displays expanded list item 630, which displays sender and subject information of a plurality of the email messages categorized within the focused list item.

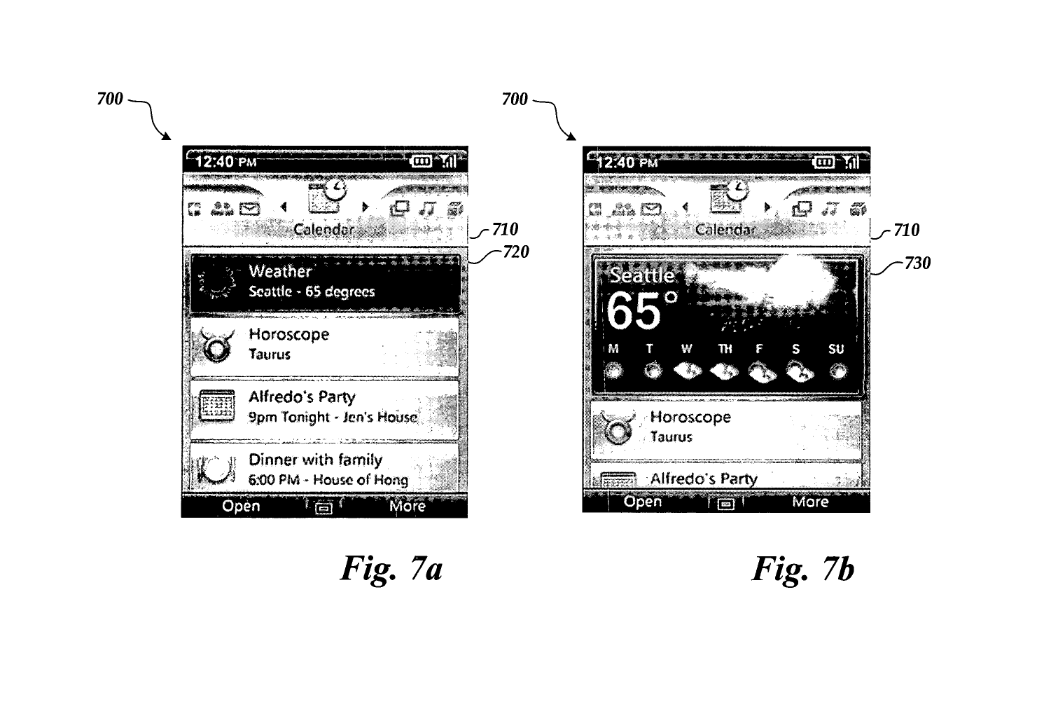

FIG. 7A is an illustration of a display of condensed list items of various types of preview information. Types of preview information can include topics such as weather, advice, scheduling information, task lists and the like, for example. Display 700 displays a list 710 of condensed items 720, which display categories of preview information.

FIG. 7B is an illustration of a display of a focused list item of a collection of email messages on a device. When a user focuses upon a condensed item 720, the list item is expanded to produce an expanded list item 730. Display 700 displays expanded list item 730, which displays additional information related to the focused upon condensed list item. The additional information can be, for example, located and downloaded when the condensed list item is focused upon. In other embodiments, the information can be downloaded and cached when the list is condensed for display.

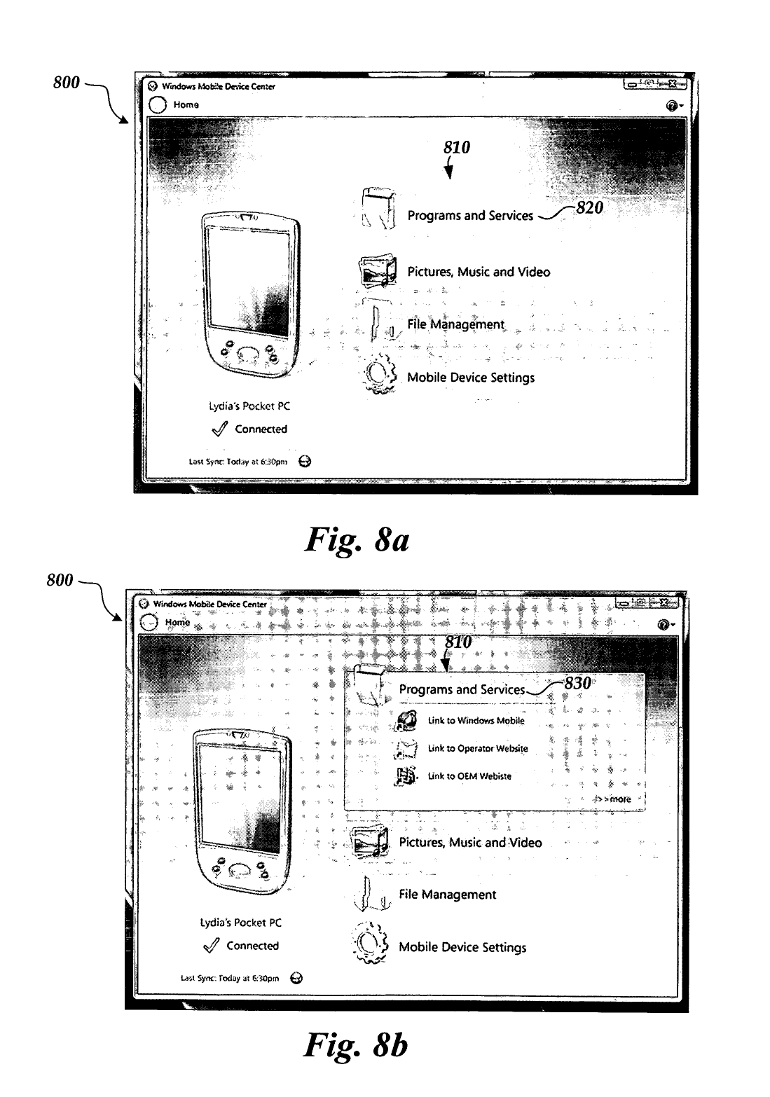

FIG. 8A is an illustration of a desktop display of condensed list items of preview information. Types of preview information can include topics such as various types programs and services, media, file management, mobile device settings and the like, for example. Display 800 displays a list 810 of condensed items 820, which display categories of preview information.

FIG. 8B is an illustration of a display of a focused list item of a collection of programs and services on a device having a desktop display. When a user focuses upon a condensed item 820, the list item is expanded to produce an expanded list item 830. Display 800 displays expanded list item 830, which displays additional services related to the focused upon condensed list item. The additional services can be, for example, located and downloaded when the condensed list item is focused upon. In other embodiments, the services can be downloaded and cached when the list is condensed for display.

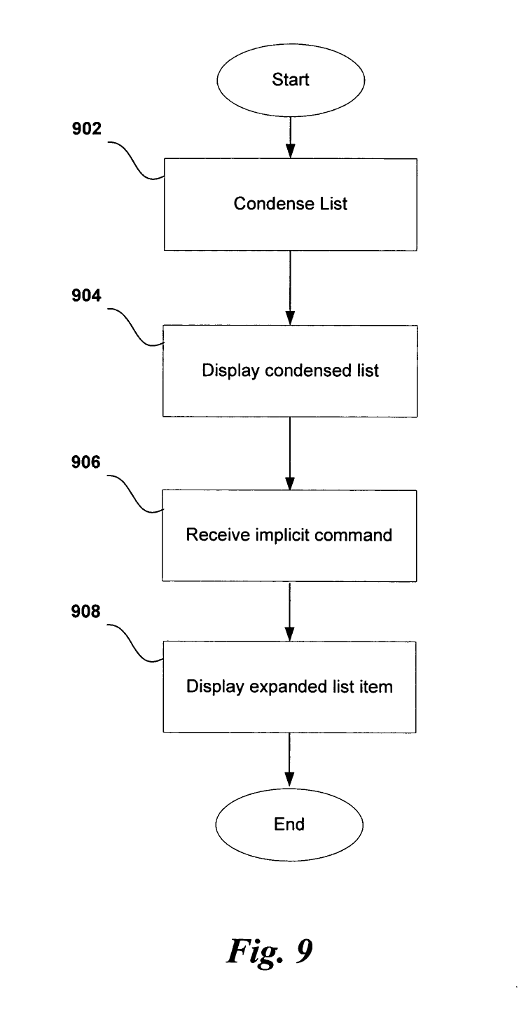

FIG. 9 is a top-level illustration of a flow diagram for preview expansion of list items. In operation 902, list items in a user-provided list can be condensed. The list can comprise, for example, email, text messages, contact list information, scheduling information, photographs, news and media sources, and the like. The list can be condensed by parsing the list and using means to represent the list in a short fashion to the user.

The list item can be represented, for example, with a caption, icon, sender and/or subject line, priority and/or schedule information, thumbnail, and the like. By representing each item in a shortened fashion, the list itself can thus be more fully represented in a given amount of area on a display.

The list can be provided, for example, by the user and/or by a content provider. The user can select the categories and/or the means by which the list items can be represented in a shortened fashion to the user. Additionally, content providers can “push” the condensed information to the user's device, normally when the user opted to receive such information.

In operation 904, a plurality of the condensed list items are displayed. The number of items that can be displayed on the display (especially on mobile and handheld devices) often exceeds the capability to display the items, so a user interface, using a scrollable list format (for example), can be used to enable each item to be displayed by scrolling.

In operation 906, an implicit command is received from a user that indicates that the user's attention is focused on a caption that is associated with a condensed list item. The implicit command can be given, for example, by the user moving a cursor over and/or hovering the cursor over a desired list item. Thus the user can implicitly indicate the user's focus on a particular list item.

In operation 908, expanded information associated with the focused list item is displayed when the implicit command is received. The expanded information associated with the focused list item can comprise at least two types of information. One type of information can be information from the list that is not displayed when the condensed list is displayed. For example, thumbnails of images can be displayed.

Another type of information can be located (using a URL and/or local storage, for example) and accessed to be included in the expanded display of the list item. Thus a service, such as a weather forecast or flight information for example, can be accessed and included in the expanded information.

Various embodiments comprise features for allowing customization of the expansion of list items. For example, third parties may wish to provide different “skins” (e.g., a user interface that has a particular style or theme). An application programmer's interface can be provided to allow third party programmers to control the look and feel of the expansion of items, as well as control parameters (such as cursor dwell time above a list item) for recognizing and interpreting implicit commands. A schema can be used also by third parties to provide content for the expanded information that is associated with a focused list item.

The above specification, examples and data provide a complete description of the manufacture and use of embodiments of the invention. Since many embodiments of the invention can be made without departing from the spirit and scope of the invention, the invention resides in the claims hereinafter appended.

We claim:

1. A computer-implemented method for displaying information from lists in limited display area devices, comprising:
displaying a plurality of condensed list items;
receiving an implicit command from a user that indicates that the user's attention is focused on a list item; and
in response to the implicit command, displaying expanded information associated with the focused list item.

2. The method of claim 1 wherein the condensed list items are generated from a list that comprises information that is associated with the user.

3. The method of claim 2 wherein the list information comprises text messages sent from third parties to the user.

4. The method of claim 2 wherein the expanded information comprises list information that is not in the displayed plurality of list items.

5. The method of claim 1 wherein the condensed list items are generated from a list that comprises list items in categories that are selected by the user.

6. The method of claim 5 wherein the expanded information comprises information that is not in the displayed plurality of list items and that is retrieved from another device using a locator associated with the focused list item.

7. The method of claim 6 wherein the implicit command is performed by hovering a curser over a list item.

8. The method of claim 7 wherein the implicit command is received from the user by a user interface.

9. The method of claim 1 wherein an application program interface is used to associate the expanded information with the focused list item.

10. The method of claim 1 wherein a schema is used by third parties to provide content for the expanded information that is associated with the focused list item.

11. The method of claim 1 wherein the plurality of condensed list items is condensed using priorities of the list from which the plurality of condensed list items are condensed.

12. A system for displaying information from lists in limited display area devices, comprising:
a list item condenser for condensing list items from a list of user information;
a display for displaying a plurality of condensed list items;
a user interface for receiving an implicit command from a user that indicates that the user's attention is focused on a condensed list item; and
an expander for expanding information associated with the focused list item for display.

13. The system of claim 12 wherein the display is provided in a mobile device.

14. The system of claim 12 wherein the list of user information is a contact list.

15. The system of claim 12 wherein the implicit command is given by moving a cursor over a condensed list item.

16. The system of claim 12 wherein the list of user information comprises images.

17. The system of claim 16 wherein the expanded information for display comprises thumbnails of the images.

18. A tangible medium comprising computer-executable instructions for:
condensing list items in a user-provided list by parsing the user-provided list and providing a caption for the condensed list items;
displaying a plurality of captions for the condensed list items;
receiving an implicit command from a user that indicates that the user's attention is focused on a caption that is associated with a condensed list item; and
in response to the implicit command, displaying expanded information associated with the focused list item.

19. The tangible medium of claim 18 wherein the expanded information is presented hierarchically.

20. The tangible medium of claim 18 wherein the expanded information comprises text from the focused list item.
